(19) United States
(12) Patent Application Publication
(10) Pub. No.: US 2016/0177869 A1
(43) Pub. Date: Jun. 23, 2016

(54) Method for Producing a Ventilation Bore in a Thrust Bearing of a Crankcase of a Reciprocating Internal Combustion Engine

(71) Applicant: Bayerische Motoren Werke Aktiengesellschaft, Muenchen (DE)

(72) Inventors: Lars TAENZER, Unterschleissheim (DE); Hans-Rainer KROENINGER, Unterschleissheim (DE)

(21) Appl. No.: 15/047,096

(22) Filed: Feb. 18, 2016

Related U.S. Application Data
(63) Continuation of application No. 13/837,484, filed on Mar. 15, 2013, now abandoned.
Application No. 13/837,484 is a continuation of application No. PCT/EP2011/004300, filed on Aug. 26, 2011.

(30) Foreign Application Priority Data
Oct. 1, 2010 (DE) 10 2010 041 840.4

(51) Int. Cl. F02F 7/00; B23C 3/02; B23C 3/26

(52) U.S. Cl. CPC F02F 7/0053; B23C 3/26; B23C 3/02; F02F 7/0007; B23C 2220/08; B23C 2220/56; B23C 2215/24

(57) ABSTRACT

A method is provided for producing a ventilation bore in a thrust bearing of a crankcase of a reciprocating internal combustion engine by milling. The milling cutter is an angled-head milling cutter, which is introduced into the crankcase in the direction of a cylinder longitudinal axis and is moved in the direction of a crankcase longitudinal axis until the thrust bearing is perforated. Subsequently, the angled-head milling cutter is moved back in the direction of the crankcase longitudinal axis and removed from the crankcase by moving the angled-head milling cutter in the direction of the cylinder longitudinal axis. Internal stresses in the crankcase are avoided by the production of the ventilation bore, as a result of which the strength of the crankcase is increased.

### CROSS REFERENCE TO RELATED APPLICATIONS

This application is a continuation of U.S. patent application Ser. No. 13/837,484, filed in the U.S. Patent and Trademark Office on Mar. 15, 2013, which is a continuation of PCT International Application No. PCT/EP2011/004300, filed Aug. 26, 2011, which claims priority under 35 U.S.C. §119 from German Patent Application No. DE 10 2010 041 840.4, filed Oct. 1, 2010, the entire disclosures of which are herein expressly incorporated by reference.

### BACKGROUND AND SUMMARY OF THE INVENTION

The invention relates to a method for producing a ventilation bore in a thrust bearing of a crankcase of a reciprocating internal-combustion engine.

With respect to the technical environment, reference is made, for example, to German Published Patent Application DE 10 2006 028 801 A1, in which it is disclosed that a ventilation bore in a thrust bearing of a crankcase of a reciprocating internal-combustion engine can be produced by milling.

From U.S. Published Patent Application US 2005/0045121 A1, on which the present invention is based, it is also known to produce ventilation bores in a thrust bearing of a crankcase of a reciprocating internal-combustion engine by milling. In this case, a milling cutter is moved from the cylinder head side diagonally through a cylinder bore in the direction of the thrust bearing, and, subsequently, the first side of the ventilation bore is milled out of the thrust bearing. Then, again coming from the cylinder head side, the milling cutter is moved diagonally through an adjacent cylinder bore in the direction of the same thrust bearing, and, subsequently, the second side of the ventilation bore is milled into the thrust bearing.

The disadvantage of this method is the required machining from two sides, which results in relatively high manufacturing expenditures. Furthermore, this machining method leads to an acute cut-back geometry causing stress peaks (high internal stress) in the crankcase and thereby reducing the stability of the crankcase.

It is an object of the present invention to avoid the above-mentioned disadvantages.

This and other objects are achieved by a method for producing a ventilation bore in a thrust bearing of a crankcase of a reciprocating internal-combustion engine by milling via a milling cutter, as well as to a correspondingly produced crankcase. The milling cutter is an angled-head milling cutter, which is inserted into the crankcase in the direction of a longitudinal cylinder axis, and is moved in the direction of a longitudinal crankcase axis until the thrust bearing has been perforated. Subsequently, the milling cutter is moved back in the direction of the longitudinal crankcase axis, and removed from the crankcase by moving the milling cutter in the direction of the longitudinal cylinder axis.

In accordance with the method of the present invention, the machining of the ventilation bores takes place in the direction of the longitudinal axis of the crankcase (longitudinal axis of the engine) and thereby prevents the creation of stress peaks (high internal stress as a result of stress concentration), because, in this case, no acute cut-back geometry (pointed edges) is created as a result of the machining course of the tools. Furthermore, the ventilation bore is advantageously produced in only one operation, whereby the production-related expenditures for the making of the ventilation bore are cut almost in half. Preferably, the machining takes place with a 90°-angled head by use of an end-milling cutter in order to, if possible, minimize further stress.

By moving the milling cutter in the direction of a plane perpendicular to the longitudinal crankcase axis after the thrust bearing has been perforated, it becomes possible to also produce noncircular ventilation bores which are designed to be optimized, i.e. be as large as possible, with respect to the ventilation cross-section.

A finished crankcase produced according to the inventive method corresponds to a conventional crankcase and may have a ventilation bore with a circular cross-section.

A finished crankcase may also have ventilation bores with a non-circular cross-section, which ventilation bores may provide an optimized flow cross-section, such as a flattened cross-section in an area of a bottom dead center of the cylinder piston.

In a particularly preferred embodiment, the method according to the invention is particularly suitable for crankcases whose cylinder running surfaces have an LDS coating (wire arc spraying). The ventilation bore is particularly preferably further developed such that the geometry of the ventilation opening is constructed in a shape- and stability-optimized manner, and thereby the deformation of the thrust bearing and, particularly, of the LDS layer, will be avoided. As a result, piston rings with lower piston ring prestressing can be used which, because of the lower friction, reduce fuel consumption.

During wire arc spraying, molten iron particles are thrown at a high speed against a surface. This thermal method is used, for example, for the coating of running paths of light-alloy cylinders in the crankcase, which ensures a particularly low-friction operation. It thereby replaces the liners which normally provide a wear-resistant surface for the cylinder running path.

During wire arc spraying, two current-carrying wires are guided together. As soon as they come in contact with one another, there will be a short circuit. The wire ends will melt as a result of the high heating, and the liquid metal is atomized and sprayed by way of a gas flow. Finally, the thus accelerated metal particles form a thin layer on the cylinder running path. Friction and wear are thereby clearly reduced in the reciprocating internal-combustion engine. In addition, space, as well as between 7 and 12% of the weight, are saved as a result of the elimination of the cylinder liners. Furthermore, the thermal properties of the layer are advantageous: the layer removes heat in the combustion chamber better than a cylinder liner and contributes to more efficient cooling.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a sectional view of an exemplary crankcase produced according to the invention.

### DETAILED DESCRIPTION OF THE DRAWING

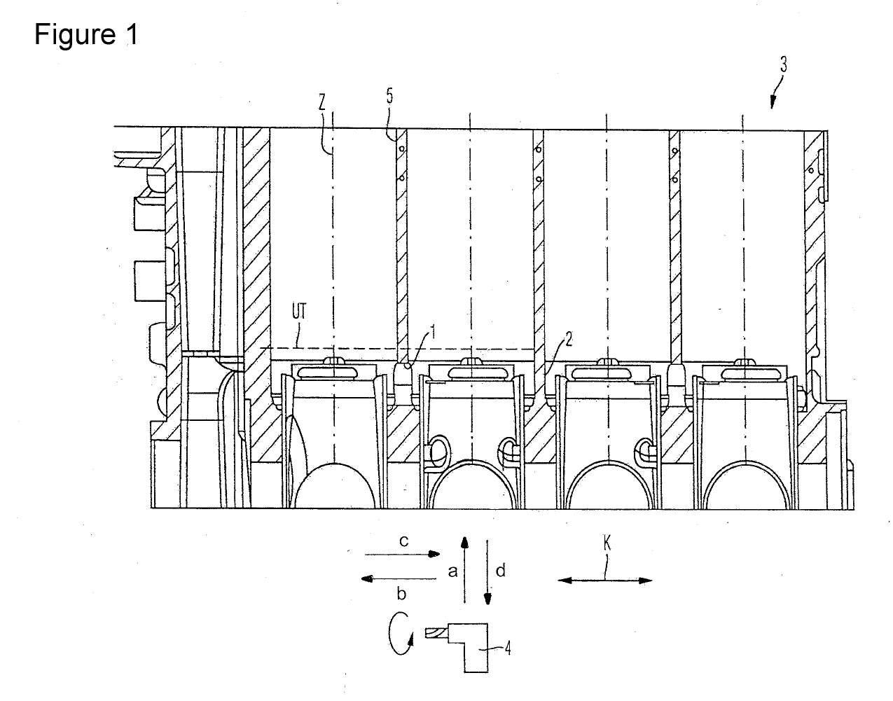

FIG. 1 is a sectional view taken along a longitudinal axis (K) of the crankcase 3 and a longitudinal axis (Z) of a cylinder of the crankcase 3 produced according to the invention. As an example, the crankcase 3 for a four-cylinder internal-combustion engine is shown, which, however, should not represent a limitation because the method according to the invention can be used for any arbitrary crankcase.

Correspondingly, the crankcase 3 has four cylinders with cylinder running surfaces 5, one thrust bearing 2 respectively being arranged between two adjacent cylinders. In the second and fourth thrust bearings 2, two ventilation bores 1 are arranged, which are indicated by a surrounding circle. Each cylinder has a longitudinal cylinder axis (Z) indicated by a dash-dotted line; the crankcase 3 has a longitudinal crankcase axis (K) indicated by a double arrow. A bottom dead center (UT) of the piston is indicated by a broken line.

The method for producing the ventilation bore 1 in the thrust bearing 2 of the crankcase 3 of a reciprocating internal-combustion engine by milling with a schematically illustrated milling cutter 4 has the following process steps:

(a) inserting the milling cutter 4, which is an angled-head milling cutter into the crankcase 3 (arrow a), in the direction of the longitudinal axis (Z) of the cylinder;

(b) moving the milling cutter 4 in the direction of the longitudinal crankcase axis (K) until the thrust bearing 2 has been perforated (arrow b), and subsequently;

(c) returning the milling cutter 4 in the direction of the longitudinal crankcase axis (K) (arrow c); and

(d) removing the milling cutter 4 from the crankcase 3 by moving the milling cutter 4 in the direction of the longitudinal cylinder axis (Z) (arrow d).

By way of these process steps according to the invention, it becomes possible to place circular ventilation bores 1 in the thrust bearing 2.

By way of a further, particularly preferred process step, the milling cutter 4, after the thrust bearing 2 has been perforated, is moved in the direction of a plane perpendicular to the longitudinal axis (K) of the crankcase. By means of this additional process step, it becomes possible to produce ventilation bores 1 with a noncircular cross-section. As a result, a maximal flow cross-section for the air can be represented, whereby the flow losses are clearly reduced, and the rigidities of the thrust bearing and of the cylinder running surfaces 5 are increased.

Particularly preferably, the ventilation bore 1 has a flattened cross-section in the area of the bottom dead center (UT) of the piston. It thereby becomes possible to move the ventilation bore as closely as possible to the bottom dead center (UT) of the piston and to achieve an optimal flow cross-section. This is particularly preferably used when the cylinder running surface 5 has an LDS coating (wire arc spraying). This embodiment advantageously permits the machining of only crankcase material and not the running path coating, since that would have a very negative effect on the service life of the tools because of the very hard LDS layer.

The invention therefore describes the further development of a ventilation opening 1 such that the geometry of the ventilation opening 1 has a shape- and stability-optimized construction, and the deformation of the thrust bearing 2 and, for example, the LDS layer can thereby be avoided. As a result, piston rings with lower piston ring prestressing can be used, which reduce fuel consumption because of the low friction. In the example of a 4-cylinder reciprocating internal-combustion engine, only the main bearings two and four are machined in order to obtain a deformation that is as low as possible. Because of the higher forces, the main bearing 2 cannot be machined. The machining preferably takes place with a 90°-angled head by use of an end-milling cutter, in order to minimize further stress, if possible. The processing takes place in the direction of the longitudinal crankcase axis (K) and thereby prevents the occurrence of stress peaks (high internal stress concentration), since, in this case, no acute cut-back geometry—as known from the state of the art—is created by the machining course of the tools.

### List of Reference Symbols

1 Ventilation bore

2 Thrust bearing

3 Crankcase

4 Milling cutter

5 Cylinder running surface

Z Longitudinal cylinder axis

K Longitudinal crankcase axis

UT Bottom dead center of piston

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a ventilation bore in a thrust bearing of a crankcase of a reciprocating internal-combustion engine, the method comprising the acts of:
inserting an angled-head milling cutter into the crankcase in a direction of a longitudinal cylinder axis;
moving the angled-head milling cutter in a direction of a longitudinal crankcase axis until the entire thrust bearing is perforated in a single cutting operation of the angled-head milling cutter;
subsequently, moving the angled-head milling cutter back in a direction of the longitudinal crankcase axis; and
removing the angled-head milling cutter from the crankcase in the direction of the cylinder longitudinal axis.

2. The method according to claim 1, further comprising the act of:
moving the angled-head the milling cutter in a direction of a plane perpendicular to the longitudinal crankcase axis after the thrust bearing has been perforated.

3. A crankcase produced in accordance with the method of claim 1, wherein the perforating of the thrust bearing creates a ventilation bore having a circular cross-section.

4. A crankcase produced in accordance with the method of claim 2, wherein the perforating of the thrust bearing creates a ventilation bore having a circular cross-section.

5. A crankcase produced according to the method of claim 2, wherein the perforating of the thrust bearing creates a ventilation bore having a non-circular cross-section.

6. A crankcase produced according to the method of claim 2, wherein the perforating of the thrust bearing and the moving of the milling cutter in the direction of the plane perpendicular to the longitudinal crankcase axis creates a ventilation bore having a flattened cross-section in an area of a bottom dead center of a piston.

7. A crankcase produced according to the method of claim 1, wherein a cylinder running surface of the crankcase has a wire arc spraying (LDS) coating.

8. A crankcase produced according to the method of claim 2, wherein a cylinder running surface of the crankcase has an LDS coating.

9. A crankcase produced according to the method of claim 2, wherein the angled-head milling cutter rotates about the longitudinal crankcase axis.
